(19) United States
(12) Patent Application Publication
(10) Pub. No.: US 2026/0030924 A1
(43) Pub. Date: Jan. 29, 2026

(54) RE-IDENTIFICATION METHOD, STORAGE MEDIUM, DATABASE EDITING METHOD AND STORAGE MEDIUM

(71) Applicant: CRSC COMMUNICATION & INFORMATION GROUP COMPANY LTD., Beijing (CN)

(72) Inventors: Jing LUO, Beijing (CN); Qingqing LEI, Beijing (CN); Shaojiang MAO, Beijing (CN); Xiao WANG, Beijing (CN); Yupeng GUO, Beijing (CN); Feng REN, Beijing (CN); Peiran LI, Beijing (CN)

(21) Appl. No.: 18/996,995

(22) PCT Filed: Jul. 28, 2023
(86) PCT No.: PCT/CN2023/109760

§ 371 Date: Jan. 18, 2025

(30) Foreign Application Priority Data
Oct. 8, 2022 (CN) 202211222394.6

(51) Int. Cl. G06V 40/16; G06V 20/54

(52) U.S. Cl. CPC G06V 40/173; G06V 20/54; G06V 2201/07

(57) ABSTRACT

The present disclosure provides a re-identification method, including: acquiring a captured image; determining, according to the captured image, coordinate information and multiple local blocks of the pedestrian to be identified; inputting the coordinate information and the multiple local blocks into a pedestrian re-identification model to obtain a corresponding global pedestrian feature and multiple local pedestrian features; obtaining a global pedestrian re-identification result according to the global pedestrian feature and global pedestrian features of multiple identified pedestrians pre-stored in a database; obtaining a local pedestrian re-identification result according to the local pedestrian features and local pedestrian features of multiple identified pedestrians pre-stored in the database; and determining an identified pedestrian corresponding to the pedestrian to be identified according to the global pedestrian re-identification result and the local pedestrian re-identification result. The present disclosure further provides a computer-readable storage medium, a database editing method, and a computer-readable storage medium.

### TECHNICAL FIELD

Embodiments of the present disclosure relate to, but are not limited to, the field of surveillance, and particularly relate to a re-identification method, a computer-readable storage medium having a pedestrian re-identification program stored thereon for implementing the re-identification method, a database editing method, and a computer-readable storage medium having a database editing program stored thereon for implementing the database editing method.

### BACKGROUND

Re-identification (ReID) is a technology for finding a target to be searched in an image library (database) by an algorithm, which, when the face is not captured by a surveillance camera, can find a target object in a video sequence in place of face identification by implementing re-identification and confirming the identity of a captured pedestrian.

### SUMMARY

The present disclosure provides a re-identification method, a computer-readable storage medium having a pedestrian re-identification program stored thereon for implementing the re-identification method, a database editing method, and a computer-readable storage medium having a database editing program stored thereon for implementing the database editing method.

In a first aspect, the present disclosure provides a re-identification method, including:
acquiring a captured image obtained by capturing a pedestrian to be identified;
determining, according to the captured image, coordinate information of the pedestrian to be identified and a plurality of local blocks of the pedestrian to be identified, wherein the plurality of local blocks include a head local block, an upper body local block, and a lower body local block;
inputting the coordinate information and the plurality of local blocks of the pedestrian to be identified into a pedestrian re-identification model to obtain a global pedestrian feature and a plurality of local pedestrian features corresponding to the pedestrian to be identified, wherein the plurality of local pedestrian features include a head feature, an upper body feature and a lower body feature;
obtaining a global pedestrian re-identification result corresponding to the pedestrian to be identified according to the global pedestrian feature corresponding to the pedestrian to be identified and global pedestrian features corresponding to a plurality of identified pedestrians pre-stored in a database; and obtaining a local pedestrian re-identification result corresponding to the pedestrian to be identified according to the plurality of local pedestrian features corresponding to the pedestrian to be identified and a plurality of local pedestrian features of the plurality of identified pedestrians pre-stored in the database; and
determining an identified pedestrian corresponding to the pedestrian to be identified according to the global pedestrian re-identification result and the local pedestrian re-identification result, to implement re-identification of the pedestrian to be identified.

In some implementations, determining, according to the captured image, coordinate information of the pedestrian to be identified and the plurality of local blocks of the pedestrian to be identified includes:
inputting the captured image into a global pedestrian detection model to obtain the coordinate information of the pedestrian to be identified, and inputting the coordinate information of the pedestrian to be identified into a local pedestrian detection model to obtain the plurality of local blocks of the pedestrian to be identified.

In some implementations, the re-identification method further includes:
training based on a yolov5 algorithm to obtain the global pedestrian detection model and the local pedestrian detection model.

In some implementations, the re-identification method further includes:
training with a pedestrian re-identification data set to obtain the pedestrian re-identification model.

In some implementations, the global pedestrian re-identification result includes a global matching probability of the global pedestrian feature of the pedestrian to be identified to the global pedestrian feature of each identified pedestrian in the database, and the local pedestrian re-identification result includes a local matching probability of the plurality of local pedestrian features of the pedestrian to be identified to the plurality of the local pedestrian features of each identified pedestrian in the database; and
determining the identified pedestrian corresponding to the pedestrian to be identified according to the global pedestrian re-identification result and the local pedestrian re-identification result includes:
performing weighted computations on the global matching probability and the local matching probability of the pedestrian to be identified to each identified pedestrian, to obtain a fused matching probability of the pedestrian to be identified to each identified pedestrian, and determining an identified pedestrian with the highest fused matching probability as the identified pedestrian corresponding to the pedestrian to be identified.

In some implementations, the global pedestrian feature and the local pedestrian features are multi-dimensional features, the global matching probability is positively correlated with a cosine similarity between the global pedestrian feature of the pedestrian to be identified and the global pedestrian feature of the identified pedestrian, and the local matching probability is positively correlated with a cosine similarity between the local pedestrian features of the pedestrian to be identified and the local pedestrian features of the identified pedestrian.

In a second aspect, the present disclosure provides a computer-readable storage medium having a pedestrian re-identification program stored thereon which, when executed by a processor, causes the re-identification method as described above to be implemented.

In a third aspect, the present disclosure provides a database editing method for obtaining the database used in the re-identification method as described above, including:
acquiring a plurality of captured images including image information of a plurality of identified pedestrians;
determining, according to the plurality of captured images, coordinate information of the plurality of identified pedestrians and a plurality of local blocks of each identified pedestrian, wherein the plurality of local blocks include a head local block, an upper body local block, and a lower body local block;
inputting the coordinate information and the plurality of local blocks of the plurality of identified pedestrians into a pedestrian re-identification model to obtain a global pedestrian feature and a plurality of local pedestrian features corresponding to each identified pedestrian, wherein the plurality of local pedestrian features include a head feature, an upper body feature and a lower body feature;
storing the global pedestrian feature and the plurality of local pedestrian features corresponding to each identified pedestrian into the database.

In some implementations, determining, according to the plurality of captured images, coordinate information of the plurality of identified pedestrians and a plurality of local blocks of each identified pedestrian, wherein the plurality of local blocks include a head local block, an upper body local block, and a lower body local block includes:
inputting the plurality of captured images into a global pedestrian detection model to obtain the coordinate information of the plurality of identified pedestrians, and inputting the coordinate information of the plurality of identified pedestrians into a local pedestrian detection model to obtain the plurality of local blocks of each identified pedestrian.

In a fourth aspect, the present disclosure provides a computer-readable storage medium having a database editing program stored thereon which, when executed by a processor, causes the database editing method as described above to be implemented.

In the re-identification method, the computer-readable storage medium having a pedestrian re-identification program stored thereon for implementing the re-identification method, the database editing method, and the computer-readable storage medium having a database editing program stored thereon for implementing the database editing method of the present disclosure, the re-identification method includes firstly determining, according to the captured image, a global image (i.e., coordinate information) and local images of various body parts (i.e., a plurality of local blocks) of the pedestrian to be identified, then extracting the global pedestrian feature in the global image and the local pedestrian features in the local images of the pedestrian to be identified, respectively, and finally obtaining a global pedestrian re-identification result based on the global pedestrian feature and a local pedestrian re-identification result based on the local pedestrian features, respectively, and the global pedestrian re-identification result and the local pedestrian re-identification result are fused in a decision-making layer to obtain a final pedestrian re-identification result.

The present disclosure considers both the global and local features of the pedestrian, and extracts more robustly the pedestrian features, where the global feature focuses on the pedestrian as a whole, the local feature focuses on fine-grained information of the pedestrian, and the two types of complementary features effectively improve the accuracy of pedestrian identification by pedestrian re-identification.

### BRIEF DESCRIPTION OF DRAWINGS

In order to explain the technical solutions in the embodiments of the present disclosure more clearly, the drawings to be used in the description of the embodiments will be briefly described below. It will be apparent that the drawings in the following description are merely some embodiments of the present disclosure, and other drawings may be derived from these drawings by those of ordinary skill in the art without any creative layer.

FIG. 1 is a schematic flowchart of an existing pedestrian re-identification technology;

FIG. 2 is a schematic flowchart of a re-identification method according to an embodiment of the present disclosure; and

FIG. 3 is a schematic flowchart of a database editing method according to an embodiment of the present disclosure.

### DETAIL DESCRIPTION OF EMBODIMENTS

Hereinafter, specific implementations of the present disclosure will be described with respect to the accompanying drawings. It will be appreciated that the specific implementations as set forth herein are merely for the purpose of illustration and explanation of the present disclosure and should not be constructed as a limitation thereof.

Most pedestrian re-identification technologies in the industry implement pedestrian re-identification based on a global image of a target. Generally, although a pedestrian re-identification model can learn pedestrian features of a strong representational capability, most pedestrians have strong similarity under the influence of various factors in real scenes, such as dressing, postures, hair styles and the like, and pedestrians are often blocked in some public places, making it very easy to neglect lots of detailed information of important significance on the pedestrians. Compared with global features, local features are often abundant in an image and have little correlation with each other, so that the expressive capability of other features will not be influenced due to disappearance of a certain local feature when the local features are blocked, but focusing on the local features may easily lead to neglect of the integrity of the pedestrian.

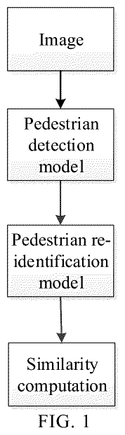

Specifically, the pedestrian re-identification in the industry typically takes a pedestrian global feature as a basis for judgment, and a convolutional neural network is used to directly input an image into the convolutional network to extract features, which cannot pay attention to significant features of the pedestrian and thus brings little improvement in the performance. As shown in FIG. 1, most pedestrian re-identification technologies in the industry are divided into 3 steps, i.e., firstly obtaining coordinates of a pedestrian in an image through a pedestrian detection algorithm (pedestrian detection algorithm model) based on the image; then obtaining a global feature of the pedestrian through the pedestrian re-identification model; and finally computing similarity between the feature of the pedestrian and features of pedestrians in a database according to a distance measurement algorithm, where a pedestrian with the highest similarity is regarded as the same pedestrian.

As a distance from the pedestrian to an observer changes, the observer often focuses on varied features during observation on the pedestrian. When the pedestrian is farther away from the observer, the observer often judges whether he/she knows the pedestrian based on an overall profile of the pedestrian; and when the pedestrian is closer to the observer, the observer often makes a judgement by focusing on an upper body, in particular a face, of the pedestrian. The existing pedestrian re-identification technology can only identify a pedestrian global feature instead of comprehensively considering local features of the pedestrian, making it hard to reach the accuracy that enables identification of an identity of the pedestrian by a human observer.

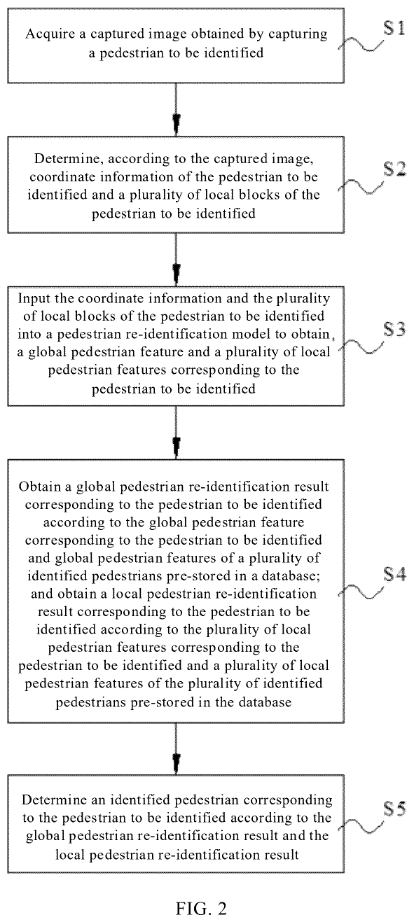

In a first aspect, the present disclosure provides a re-identification method which, as shown in FIG. 2, includes the following steps S1 to S5.

At step S1, acquiring a captured image obtained by capturing a pedestrian to be identified.

At step S2, determining, according to the captured image, coordinate information (i.e., information indicating a position of the image of the pedestrian to be identified in the captured image, which may be, for example, a coordinate box) of the pedestrian to be identified and a plurality of local blocks of the pedestrian to be identified, where the plurality of local blocks include a head local block, an upper body local block, and a lower body local block.

At step S3, inputting the coordinate information and the plurality of local blocks of the pedestrian to be identified into a pedestrian re-identification model to obtain a global pedestrian feature and a plurality of local pedestrian features corresponding to the pedestrian to be identified, where the plurality of local pedestrian features include a head feature, an upper body feature and a lower body feature.

At step S4, obtaining a global pedestrian re-identification result corresponding to the pedestrian to be identified according to the global pedestrian feature corresponding to the pedestrian to be identified and global pedestrian features of a plurality of identified pedestrians pre-stored in a database; and obtaining a local pedestrian re-identification result corresponding to the pedestrian to be identified according to the plurality of local pedestrian features corresponding to the pedestrian to be identified and a plurality of local pedestrian features of the plurality of identified pedestrians pre-stored in the database.

At step S5, determining an identified pedestrian corresponding to the pedestrian to be identified according to the global pedestrian re-identification result and the local pedestrian re-identification result (i.e., determining that the identified pedestrian is the same as the pedestrian to be identified), to implement re-identification of the pedestrian to be identified.

In the re-identification method of the present disclosure, firstly in step S2, according to the captured image, a global image (i.e., coordinate information) and local images of various body parts (i.e., a plurality of local blocks) of the pedestrian to be identified are determined, then in step S3, the global pedestrian feature in the global image and the local pedestrian features in the local images of the pedestrian to be identified are extracted, and finally in step S4, a global pedestrian re-identification result based on the global pedestrian feature and a local pedestrian re-identification result based on the local pedestrian features are obtained, respectively, and in step S5, the global pedestrian re-identification result and the local pedestrian re-identification result are then fused in a decision-making layer to obtain a final pedestrian re-identification result (i.e., to determine which identified pedestrian in the database corresponds to the pedestrian to be identified). The re-identification method of the present disclosure considers both the global and local features of the pedestrian, and extracts more robustly the pedestrian features, where the global feature focuses on the pedestrian as a whole, the local feature focuses on fine-grained information of the pedestrian, and the two types of complementary features effectively improve the accuracy of pedestrian identification by pedestrian re-identification technologies.

In one embodiment, step S2 may be implemented by a trained model. Specifically, determining, according to the captured image, coordinate information of the pedestrian to be identified and the plurality of local blocks of the pedestrian to be identified may specifically include:
inputting the captured image into a global pedestrian detection model to obtain the coordinate information of the pedestrian to be identified, and inputting the coordinate information of the pedestrian to be identified into a local pedestrian detection model to obtain the plurality of local blocks of the pedestrian to be identified.

In one embodiment, the re-identification method further includes:
training based on a yolov5 algorithm to obtain the global pedestrian detection model and the local pedestrian detection model.

In one embodiment, the re-identification method further includes:
training with a pedestrian re-identification data set to obtain the pedestrian re-identification model.

In one embodiment, the pedestrian re-identification data set may be a Market1501 data set.

In one embodiment, the global pedestrian re-identification result includes a global matching probability of the global pedestrian feature of the pedestrian to be identified to the global pedestrian feature of each identified pedestrian in the database, and the local pedestrian re-identification result includes a local matching probability of the plurality of local pedestrian features of the pedestrian to be identified to the plurality of the local pedestrian features of each identified pedestrian in the database; and Specifically, step S5 includes:
performing weighted computations on the global matching probability and the local matching probability of the pedestrian to be identified to each identified pedestrian, to obtain a fused matching probability of the pedestrian to be identified to each identified pedestrian, and determining an identified pedestrian with the highest fused matching probability as the identified pedestrian corresponding to the pedestrian to be identified.

In the existing art, pedestrian re-identification is performed through the pedestrian global feature only. In other words, the pedestrian global feature of the pedestrian to be identified is compared with pedestrian global features of all identified pedestrians, and then an identified pedestrian with the highest matching probability is directly determined as the identified pedestrian corresponding to the pedestrian to be identified. In an embodiment of the present disclosure, a global matching probability and a local matching probability of the pedestrian to be identified to each identified pedestrian are obtained in step S4, but instead of picking out a maximum value of all global matching probabilities or picking out a maximum value of all local matching probabilities, weighted computations are performed on all the global matching probabilities and the corresponding local matching probabilities in step S5 (where a sum of weight coefficients of the global matching probabilities and the local matching probabilities is 1), to obtain a fused matching probability of the pedestrian to be identified to each identified pedestrian, so that the global and local features of the pedestrian are fused, and the pedestrian identification rate is increased.

In one embodiment, the global pedestrian feature and the local pedestrian features are multi-dimensional features, the global matching probability is positively correlated with a cosine similarity between the global pedestrian feature of the pedestrian to be identified and the global pedestrian feature of the identified pedestrian, and the local matching probability is positively correlated with a cosine similarity between the local pedestrian features of the pedestrian to be identified and the local pedestrian features of the identified pedestrian.

For example, in some implementations, the global pedestrian feature may be a 512-dimensional feature, each local pedestrian feature may also be a 512-dimensional feature, and a 512-dimensional pedestrian global feature, a 512-dimensional head feature, a 512-dimensional upper body feature, and a 512-dimensional lower body feature of each identified pedestrian are combined into a 2048-dimensional feature which is stored in the database.

During pedestrian re-identification of the pedestrian to be identified, firstly a cosine between a 512-dimensional vector corresponding to the global pedestrian feature of the pedestrian to be identified and a 512-dimensional vector corresponding to the global pedestrian feature of each identified pedestrian is computed to obtain a global matching probability (i.e., a global pedestrian re-identification result) corresponding to a cosine similarity between the global pedestrian features, then a cosine between a 1536-dimensional vector corresponding to three local pedestrian features of the pedestrian to be identified and a 1536-dimensional vector corresponding to the three local pedestrian features of each identified pedestrian is computed to obtain a local matching probability (i.e., a local pedestrian re-identification result) corresponding to a cosine similarity between the local pedestrian features, then weighted computations are performed on the global matching probability and the local matching probability corresponding to each identified pedestrian, to obtain a fused matching probability of the pedestrian to be identified to each identified pedestrian, and further, a pedestrian with the highest fused matching probability is selected as the identified pedestrian corresponding to the pedestrian to be identified, thereby completing re-identification of the pedestrian to be identified.

In a second aspect, the present disclosure provides a computer-readable storage medium having a pedestrian re-identification program stored thereon which, when executed by a processor, causes the re-identification method provided in the embodiments of the present disclosure to be implemented.

The computer-readable storage medium of the present disclosure has a pedestrian re-identification program stored thereon which, when executed by a processor, causes the re-identification method provided in the embodiments of the present disclosure to be implemented, where in the re-identification method, firstly in step S2, according to the captured image, a global image (i.e., coordinate information) and local images of various body parts (i.e., a plurality of local blocks) of the pedestrian to be identified are determined, then in step S3, the global pedestrian feature in the global image and the local pedestrian features in the local images of the pedestrian to be identified are extracted, and finally in step S4, a global pedestrian re-identification result based on the global pedestrian feature and a local pedestrian re-identification result based on the local pedestrian features are obtained, respectively, and in step S5, the global pedestrian re-identification result and the local pedestrian re-identification result are then fused in a decision-making layer to obtain a final pedestrian re-identification result (i.e., to determine which identified pedestrian in the database corresponds to the pedestrian to be identified). The re-identification method of the present disclosure considers both the global and local features of the pedestrian, and extracts more robustly the pedestrian features, where the global feature focuses on the pedestrian as a whole, the local feature focuses on fine-grained information of the pedestrian, and the two types of complementary features effectively improve the accuracy of pedestrian identification by pedestrian re-identification.

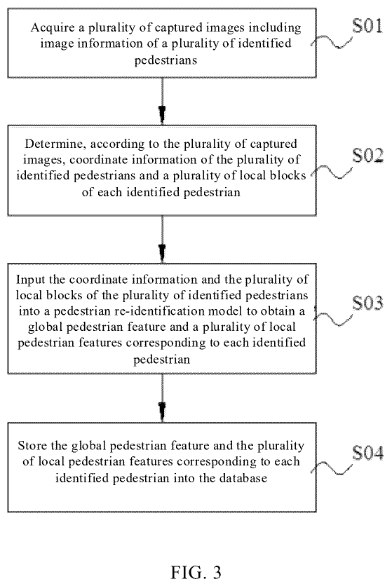

In a third aspect, the present disclosure provides a database editing method for obtaining the database used in the re-identification method provided in the embodiments of the present disclosure. As shown in FIG. 3, the database editing method includes the following steps S01 to S04.

At step S01, acquiring a plurality of captured images including image information of a plurality of identified pedestrians.

At step S02, determining, according to the plurality of captured images, coordinate information of the plurality of identified pedestrians and a plurality of local blocks of each identified pedestrian, where the plurality of local blocks include a head local block, an upper body local block, and a lower body local block.

At step S03, inputting the coordinate information and the plurality of local blocks of the plurality of identified pedestrians into a pedestrian re-identification model to obtain a global pedestrian feature and a plurality of local pedestrian features corresponding to each identified pedestrian, where the plurality of local pedestrian features include a head feature, an upper body feature and a lower body feature.

At step S04, storing the global pedestrian feature and the plurality of local pedestrian features corresponding to each identified pedestrian into the database.

With the database editing method of the present disclosure, the database used in the re-identification method provided in the embodiments of the present disclosure can be obtained, where in the re-identification method, firstly in step S2, according to the captured image, a global image (i.e., coordinate information) and local images of various body parts (i.e., a plurality of local blocks) of the pedestrian to be identified are determined, then in step S3, the global pedestrian feature in the global image and the local pedestrian features in the local images of the pedestrian to be identified are extracted, and finally in step S4, a global pedestrian re-identification result based on the global pedestrian feature and a local pedestrian re-identification result based on the local pedestrian features are obtained, respectively, and in step S5, the global pedestrian re-identification result and the local pedestrian re-identification result are then fused in a decision-making layer to obtain a final pedestrian re-identification result (i.e., to determine which identified pedestrian in the database corresponds to the pedestrian to be identified). The re-identification method of the present disclosure considers both the global and local features of the pedestrian, and extracts more robustly the pedestrian features, where the global feature focuses on the pedestrian as a whole, the local feature focuses on fine-grained information of the pedestrian, and the two types of complementary features effectively improve the accuracy of pedestrian identification by pedestrian re-identification.

In an embodiment, step S02 may be implemented by a trained model.

Specifically, determining, according to the plurality of captured images, coordinate information of the plurality of identified pedestrians and a plurality of local blocks of each identified pedestrian, wherein the plurality of local blocks include a head local block, an upper body local block, and a lower body local block includes:
inputting the plurality of captured images into a global pedestrian detection model to obtain the coordinate information of the plurality of identified pedestrians, and inputting the coordinate information of the plurality of identified pedestrians into a local pedestrian detection model to obtain the plurality of local blocks of each identified pedestrian.

In a fourth aspect, the present disclosure provides a computer-readable storage medium having a database editing program stored thereon which, when executed by a processor, causes the database editing method provided in the embodiments of the present disclosure to be implemented.

The computer-readable storage medium of the present disclosure has a database editing program stored thereon which, when executed by a processor, causes the database editing method provided in the embodiments of the present disclosure to be implemented, and enables to obtain the database used in the re-identification method provided in the embodiments of the present disclosure, where in the re-identification method, firstly in step S2, according to the captured image, a global image (i.e., coordinate information) and local images of various body parts (i.e., a plurality of local blocks) of the pedestrian to be identified are determined, then in step S3, the global pedestrian feature in the global image and the local pedestrian features in the local images of the pedestrian to be identified are extracted, and finally in step S4, a global pedestrian re-identification result based on the global pedestrian feature and a local pedestrian re-identification result based on the local pedestrian features are obtained, respectively, and in step S5, the global pedestrian re-identification result and the local pedestrian re-identification result are then fused in a decision-making layer to obtain a final pedestrian re-identification result (i.e., to determine which identified pedestrian in the database corresponds to the pedestrian to be identified). The re-identification method of the present disclosure considers both the global and local features of the pedestrian, and extracts more robustly the pedestrian features, where the global feature focuses on the pedestrian as a whole, the local feature focuses on fine-grained information of the pedestrian, and the two types of complementary features effectively improve the accuracy of pedestrian identification by pedestrian re-identification.

It will be appreciated that the above implementations are merely exemplary implementations for the purpose of illustrating the principle of the present disclosure, and the present disclosure is not limited thereto. Various modifications and improvements can be made by a person having ordinary skill in the art without departing from the spirit and essence of the disclosure. Accordingly, all of the modifications and improvements also fall into the protection scope of the present disclosure.

1. A re-identification method, comprising:
acquiring a captured image obtained by capturing a pedestrian to be identified:
determining, according to the captured image, coordinate information of the pedestrian to be identified and a plurality of local blocks of the pedestrian to be identified, wherein the plurality of local blocks comprise a head local block, an upper body local block, and a lower body local block:
inputting the coordinate information and the plurality of local blocks of the pedestrian to be identified into a pedestrian re-identification model to obtain a global pedestrian feature and a plurality of local pedestrian features corresponding to the pedestrian to be identified, wherein the plurality of local pedestrian features comprise a head feature, an upper body feature and a lower body feature:
obtaining a global pedestrian re-identification result corresponding to the pedestrian to be identified according to the global pedestrian feature corresponding to the pedestrian to be identified and global pedestrian features corresponding to a plurality of identified pedestrians pre-stored in a database: and obtaining a local pedestrian re-identification result corresponding to the pedestrian to be identified according to the plurality of local pedestrian features corresponding to the pedestrian to be identified and a plurality of local pedestrian features of the plurality of identified pedestrians pre-stored in the database: and
determining an identified pedestrian corresponding to the pedestrian to be identified according to the global pedestrian re-identification result and the local pedestrian re-identification result, to implement re-identification of the pedestrian to be identified.

2. The re-identification method according to claim 1, wherein determining, according to the captured image, coordinate information of the pedestrian to be identified and the plurality of local blocks of the pedestrian to be identified comprises:
inputting the captured image into a global pedestrian detection model to obtain the coordinate information of the pedestrian to be identified, and inputting the coordinate information of the pedestrian to be identified into a local pedestrian detection model to obtain the plurality of local blocks of the pedestrian to be identified.

3. The re-identification method according to claim 2, further comprising:
training based on a yolov5 algorithm to obtain the global pedestrian detection model and the local pedestrian detection model.

4. The re-identification method according to claims 1, further comprising:
training with a pedestrian re-identification data set to obtain the pedestrian re-identification model.

5. The re-identification method according to claims 1, wherein the global pedestrian re-identification result comprises a global matching probability of the global pedestrian feature of the pedestrian to be identified to the global pedestrian feature of each identified pedestrian in the database, and the local pedestrian re-identification result comprises a local matching probability of the plurality of local pedestrian features of the pedestrian to be identified to the plurality of the local pedestrian features of each identified pedestrian in the database; and
determining the identified pedestrian corresponding to the pedestrian to be identified according to the global pedestrian re-identification result and the local pedestrian re-identification result comprises:
performing weighted computations on the global matching probability and the local matching probability of the pedestrian to be identified to each identified pedestrian, to obtain a fused matching probability of the pedestrian to be identified to each identified pedestrian, and determining an identified pedestrian with the highest fused matching probability as the identified pedestrian corresponding to the pedestrian to be identified.

6. The re-identification method according to claim 5, wherein the global pedestrian feature and the local pedestrian features are multi-dimensional features, the global matching probability is positively correlated with a cosine similarity between the global pedestrian feature of the pedestrian to be identified and the global pedestrian feature of the identified pedestrian, and the local matching probability is positively correlated with a cosine similarity between the local pedestrian features of the pedestrian to be identified and the local pedestrian features of the identified pedestrian.

7. A computer-readable storage medium having a pedestrian re-identification program stored thereon which, when executed by a processor, causes the re-identification method according to claim 1 to be implemented.

8. A database editing method for obtaining the database used in the re-identification method according to claim 1, comprising:
acquiring a plurality of captured images comprising image information of a plurality of identified pedestrians:
determining, according to the plurality of captured images, coordinate information of the plurality of identified pedestrians and a plurality of local blocks of each identified pedestrian, wherein the plurality of local blocks comprise a head local block, an upper body local block, and a lower body local block:
inputting the coordinate information and the plurality of local blocks of the plurality of identified pedestrians into a pedestrian re-identification model to obtain a global pedestrian feature and a plurality of local pedestrian features corresponding to each identified pedestrian, wherein the plurality of local pedestrian features comprise a head feature, an upper body feature and a lower body feature: and
storing the global pedestrian feature and the plurality of local pedestrian features corresponding to each identified pedestrian into the database.

9. The database editing method according to claim 8, wherein determining, according to the plurality of captured images, coordinate information of the plurality of identified pedestrians and a plurality of local blocks of each identified pedestrian, wherein the plurality of local blocks comprise a head local block, an upper body local block, and a lower body local block comprises:
inputting the plurality of captured images into a global pedestrian detection model to obtain the coordinate information of the plurality of identified pedestrians, and inputting the coordinate information of the plurality of identified pedestrians into a local pedestrian detection model to obtain the plurality of local blocks of each identified pedestrian.

10. A computer-readable storage medium having a database editing program stored thereon which, when executed by a processor, causes the database editing method according to claim 8 to be implemented.

11. A computer-readable storage medium having a database editing program stored thereon which, when executed by a processor, causes the database editing method according to claim 9 to be implemented.
